(19) United States
(12) Patent Application Publication
(10) Pub. No.: US 2024/0412106 A1
(43) Pub. Date: Dec. 12, 2024

(54) METHOD OF GENERATING A CLASSIFICATION MODEL AND CLASSIFICATION METHOD USING SUCH A MODEL

(71) Applicant: STMicroelectronics International N.V., Geneva (CH)

(72) Inventor: He Huang, Paris (FR)

(21) Appl. No.: 18/657,283

(22) Filed: May 7, 2024

(30) Foreign Application Priority Data
Jun. 9, 2023 (FR) 2305829

(51) Int. Cl. G06N 20/00

(52) U.S. Cl. CPC G06N 20/00

(57) ABSTRACT

A computer-implemented method for generating a classification model includes: obtaining at least one group of learning data, identifying at least one characteristic to be studied of the learning data, extracting a value of each characteristic defined for all learning data, identifying ranges of values for each characteristic from the extracted values, creating a classification table, assigning a class to each cell of the classification table according to a number of occurrences of the learning data of each group according to their extracted value of each characteristic with respect to the ranges of values defined for each studied characteristic, and generating a classification model comprising the classification table.

### CROSS-REFERENCE TO RELATED APPLICATIONS

This application claims the benefit of French Patent Application No. 2305829, filed on Jun. 9, 2023, which application is hereby incorporated herein by reference.

### TECHNICAL FIELD

The present invention relates generally to learning data, and, in particular embodiments, to a method for generating a classification model.

### BACKGROUND

Computers can use classification models to classify data into categories or groups according to some characteristics. There are several types of classification models. Each classification model type has its own advantages and drawbacks depending on the type of data to be classified.

In particular, classification models include decision trees, neural networks, neighbors-based classification models, such as k-nearest neighbors (KNN) and support vector machines (SVM).

Moreover, microcontrollers are programmable integrated circuits which may be used to implement classification models.

However, microcontrollers have limits in terms of memory and computing power resources. Indeed, microcontrollers generally have a limited memory storage capacity. Microcontrollers also have a limited processing speed.

These limits could restrict their capacity to implement some classification models.

The size and the complexity of a classification model as well as the available resources on a microcontroller should be taken into account in order to determine whether or not it is possible and desirable to use the classification model on the microcontroller.

In particular, the classification models that require a lot of data storage could exceed the storage capacity of the microcontroller. Furthermore, the classification algorithms that require a lot of computations could take much time to be executed on a microcontroller.

Thus, some classification models are not suited to be used by microcontrollers. In general, microcontrollers are best suited to use simple classification models.

Hence, there is a need to provide a solution allowing carrying out a classification in a manner that is simple, quick, and inexpensive in terms of memory occupancy.

### SUMMARY

In accordance with an embodiment, a computer-implemented method is provided for generating a classification model, the method comprising: —obtaining at least one group of learning data, each group of learning data being associated with an indicated class,
identifying at least one characteristic to be studied of the learning data, —extracting a value of each characteristic found for all learning data, —setting ranges of values for each characteristic from the extracted values,
creating a classification table having a number of dimensions corresponding to the number of studied characteristics, each dimension having a size equal to the number of ranges of values set for the characteristic associated with this dimension, each cell of the classification table being associated with a range of values of each studied characteristic, —assigning a class to each cell of the classification table according to a number of occurrences of the learning data of each group according to their extracted value of each characteristic with respect to the ranges of values set for each studied characteristic, —generating a classification model comprising the classification table.

Such a generation method allows obtaining a classification model that is simple and quick to use and occupying a relatively reduced space in memory.

Hence, such a classification model may be used by a computer system including limited resources in terms of memory and computing power. In particular, such a classification model may be used by a microcontroller.

Since the classes are assigned to ranges of values of each studied characteristic, the classification model is set while avoiding an overfitting to the learning data, to improve generalization thereof to data that have not been used as learning data. The limited number of ranges of values, which is correlated with the number of learning data, also allows avoiding overfitting.

Such a classification model may also be updated easily by taking new learning data into account.

Furthermore, if the learning data are divided into several groups of different sizes, it is possible to apply a weighting on the number of occurrences of the learning data used when assigning the classes to the different cells of the classification table. Hence, such a classification model generation method is suited to unbalanced sets of learning data.

In an advantageous implementation, the classification model also includes a minimum value and a maximum value of each studied characteristic. Such a classification model may be stored in a relatively reduced space in memory.

Alternatively, the classification model may comprise all of the ranges of values for each characteristic.

In some embodiments, the class assigned to a cell of the classification table corresponds to the class of the group of learning data having the largest number of occurrences of learning data over the range of values of each characteristic associated with the cell of the classification table.

In an advantageous implementation, the class assigned to a cell of the classification table corresponds to the class having the highest probability compared to the classes assigned to the adjacent cells of the classification table if the number of occurrences of the learning data over the range of values of each characteristic associated with the cell is the same and non-zero for each group of learning data.

In an advantageous implementation, the class assigned to a cell of the classification table corresponds to an undetermined class or to the class having the highest probability compared to the classes assigned to the adjacent cells of the classification table if the number of occurrences of the learning data over the range of values of each characteristic associated with the cell is zero for each group of learning data.

In some embodiments, the ranges of values for each characteristic are set using Sturges's rule.

Advantageously, the method further comprises developing a classification computer program product comprising instructions which, when the program is executed by a computer, cause the latter to implement the generated classification model.

In accordance with another embodiment, a computer program product is provided comprising instructions which, when the program is executed by a computer, cause the latter to implement the method for generating a classification model as described before.

In accordance with yet another embodiment, a computer system is provided, comprising:
a memory comprising a computer program product comprising instructions which, when the program is executed by a computer, cause the latter to implement the method for generating a classification model as described before,
a processing unit configured to execute the computer program product.

In accordance with yet another an embodiment, a computer-implemented classification method is provided based on a classification model obtained by a generation method as described before, the classification method comprising:
obtaining data to be classified,
extracting values from the data to be classified for each characteristic identified in the classification model,
determining the class of the data to be classified from the classification table of the classification model indicating the class assigned for the extracted values.

In an advantageous implementation, the classification model includes a minimum value and a maximum value of each studied characteristic. The class assigned for the data to be classified is then found in the classification table from the values extracted from the data to be classified, the minimum and maximum values of each studied characteristic and the size of each dimension of the classification table.

In accordance with yet another embodiment, a computer program product is provided comprising instructions which, when the program is executed by a computer, cause the latter to implement the classification method as described before.

In accordance with yet another embodiment, a computer system is provided, comprising:
a memory comprising a computer program product comprising instructions which, when the program is executed by a computer, cause the latter to implement the classification method as described before,
a processing unit configured to execute the computer program product.

### BRIEF DESCRIPTION OF THE DRAWINGS

Other advantages and features of the invention will become apparent upon examining the detailed description of embodiments and implementations, without limitation, and of the appended drawings, wherein:

FIG. 1 illustrates a computer system configured to implement a method for generating a classification model, in accordance with an embodiment;

FIG. 2 illustrates an implementation of a classification model generation method, in accordance with an embodiment;

FIG. 3 illustrates a graph and histograms that can be obtained from the values of the characteristics of learning data, in accordance with an embodiment;

FIG. 4 illustrates a computer system configured to implement a classification method, in accordance with an embodiment; and

FIG. 5 illustrates a classification method which can be executed by a computer system, in accordance with an embodiment.

### DETAILED DESCRIPTION OF ILLUSTRATIVE EMBODIMENTS

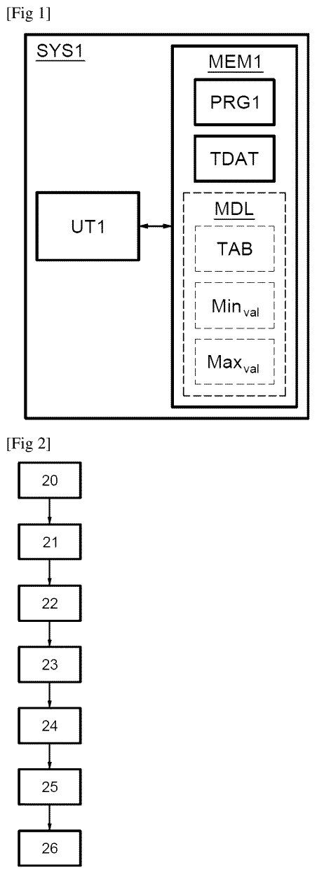

FIG. 1 illustrates an embodiment of a computer system SYS1 configured to implement a method for generating a classification model. The computer system SYS1 comprises a processing unit UT1 (e.g., a processor such as a microprocessor, microcontroller, central processing unit, or the like) and a memory MEM1. For example, such a computer system SYS1 may be a personal computer or a server.

The memory MEM1 includes a computer program PRG1 comprising instructions which, when the program PRG1 is executed by the processing unit UT1 of the computer system SYS1, cause the latter to implement the method for generating a classification model, as described later on.

The memory MEM1 is also configured to store learning data TDAT. The learning data TDAT are data used to generate the classification model MDL. The learning data TDAT are supplied by a user of the computer system SYS1 wishing to create a classification model from these learning data TDAT. The learning data TDAT may be obtained from data acquired by sensors and then supplied to the computer system SYS1. For example, the data TDAT may correspond to any type of analog or digital signal, for example images, vibration signals, current measurements, etc.

The learning data TDAT include data associated with different classes. A class is a group of data which have similar characteristics and which are grouped together according to these characteristics. Thus, the learning data are divided into several groups of learning data, each group of learning data being associated with a class indicated by the user.

More particularly, the characteristics are quantitative measurements or properties of the learning data which allow distinguishing them from one another and associating them with particular classes. The learning data may directly correspond to characteristics.

For example, the characteristics of the time-series signals may comprise amplitudes, frequencies, durations, minimums, maximums, averages, standard deviations, etc.

For example, a group of learning data may be associated with a class corresponding to normal data, and another group of learning data may be associated with a class corresponding to anomaly data.

The processing unit UT1 is configured to generate a classification model MDL by implementing the generation method. In particular, the processing unit UT1 is configured to generate a classification model MDL by executing the computer program PRG1 by taking the classification data TDAT as input.

FIG. 2 illustrates an implementation of a classification model generation method which can be executed by a computer system as described before.

The method comprises obtaining 20 learning data TDAT associated with different classes. Thus, each class is created with a group of learning data.

The method comprises identifying 21 at least one characteristic of the learning data to be studied to classify the learning data. In particular, it is possible to identify one single characteristic to be studied or several characteristics to be studied. These characteristics are set by the user.

Afterwards, the method comprises extracting 22 the values of the characteristics for the different learning data. If the learning data correspond directly to characteristics, then the extraction step 22 is equivalent to a mere reading of the learning data.

Afterwards, the method comprises identifying 23 ranges of values for each characteristic of the learning data. Next, these ranges of values will be assigned to the different classes.

In particular, the ranges of values may be set by splitting the values extracted from the learning data. For example, the ranges of values may be set using Sturges's rule or Freedman-Diaconis's rule or Scott's rule, well known to a person skilled in the art.

The classification model is created from the number of occurrences of learning data with respect to the different set ranges of values.

More particularly, for each class of learning data, a table of occurrences is used to report the number of occurrences of the learning data of this class with respect to the ranges of values set for each studied characteristic.

The table of occurrences has a number of dimensions equal to the number of characteristics to be studied. Each dimension of the table has a size corresponding to the numbers of ranges of values set for the characteristic associated with this dimension. Each cell of the table is associated with a range of values of each studied characteristic. Each cell allows counting the number of occurrences of the learning data of the class associated with this table of occurrences with respect to the ranges of values of the characteristics associated with this cell.

The number of occurrences of the learning data with respect to the ranges of values is reported in the table of occurrences according to the following method. For each learning piece of data, the value of each studied characteristic extracted from this learning data is compared with the ranges of values set for this characteristic in order to determine which cell of the occurrence table should be incremented.

Each table of occurrences is stored in a memory of the computer system, for example a volatile memory of the computer system.

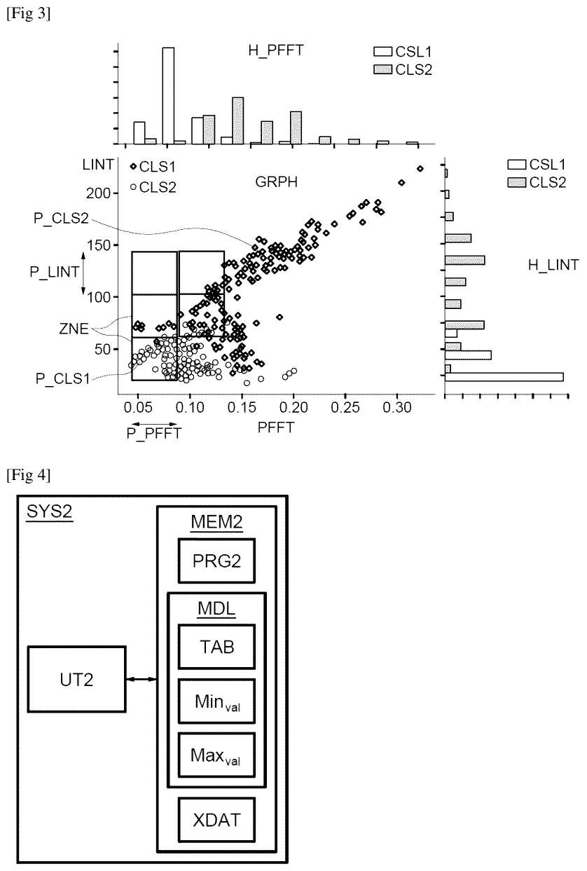

When one single characteristic is studied, each table of occurrences may be illustrated by a histogram including bins associated with the different set ranges of values. Each bin then illustrates the number of occurrences of learning data of the class associated with this histogram for the range of values of the studied characteristic associated with this bin. Such histograms are described later on with reference to FIG. 3.

The classification model MDL to be generated comprises a classification table TAB. In particular, the method comprises creating 24 such a classification table TAB. The classification table TAB has dimensions that correspond to the set characteristics. Each cell of the classification table TAB is associated with arrange of values for the different set characteristics.

The method comprises assigning 25 a class to each cell of the classification table. In particular, a class is assigned to each cell of the classification table by comparing the tables of occurrences established for the different classes of the learning data.

The class assigned to a cell corresponds to the class of the learning data for which the largest number of occurrences of the learning data is present in the ranges of values set for this cell.

If the number of occurrences of the learning data over the range of values of each characteristic associated with the cell is equal and non-zero between the different groups of learning data, then the cell of the classification table TAB is associated with the class that has the highest probability of occurrences compared to all of the learning data. In particular, the class assigned for such a cell of the classification table may be set according to the classes assigned to the adjacent cells of the classification table.

If the number of occurrences of the learning data over the range of values of each characteristic associated with the cell is zero for each group of learning data, then the class assigned to the cell of the classification table corresponds to an undetermined class or to the class having the highest probability compared to the classes assigned to the adjacent cells of the classification table.

Afterwards, the method comprises a step 26 of generating the classification model. The classification model comprises the classification table as well as the minimum value Minᵥₐₗ and the maximum value Maxᵥₐₗ of each characteristic. Alternatively to the minimum and maximum values of each characteristic, the classification model may comprise all of the ranges of values set for each characteristic.

Such a generation method allows obtaining a classification model that is simple and quick to use and occupying a relatively reduced space in memory.

Hence, such a classification model may be used by a computer system including limited resources in terms of memory and computing power. In particular, such a classification model may be used by a microcontroller. In particular, the classification model may be implemented by a computer system such as that one described later one with reference to FIG. 4.

Since the classes are assigned to ranges of values of each studied characteristic, the classification model is set while avoiding an overfitting to the learning data, to improve generalization thereof to data that have not been used as learning data.

Such a classification model may also be updated easily by taking new learning data into account.

Furthermore, if the learning data are divided into several groups of different sizes, it is possible to apply a weighting on the number of occurrences of the learning data used when assigning the classes to the different cells of the classification table. Hence, such a classification model generation method is suited to unbalanced sets of learning data.

FIG. 3 illustrates a graph GRPH as well as histograms H_PFFT and H_LINT that can be obtained from the values of the characteristics of learning data.

In this case, the learning data correspond to signals corresponding to sounds. The characteristics set for these learning data are peaks of a Fourier transform, in particular a fast Fourier transform PFFT, and curvilinear integrals LINT. A first group of learning data is associated with a first class CLS1. A second group of learning data is associated with a second class CLS2.

In particular, the abscissa of the graph GRPH corresponds to the peaks of Fourier transforms, in particular a fast Fourier transform, of the learning data. The ordinate of the graph corresponds to the values of the curvilinear integrals of the learning data.

For each learning piece of data associated with the class CLS1 or with the class CLS2, a point is plotted on the graph according to the value of the Fourier transform peak and of the curvilinear integral associated with this learning piece of data.

The points P_CLS1 correspond to the values of the characteristics of the learning data associated with the first class CLS1.

The points P_CLS2 correspond to the values of the characteristics of the learning data associated with the second class CLS2.

The histogram H_PFFT illustrates the number of occurrences of the learning data of each class CLS1, CLS2 according to the value of their Fourier transform peaks with respect to the different ranges of values P_PFFT set for the bins of the histograms.

The histogram H_LINT illustrates the number of occurrences of the learning data of each class CLS1, CLS2 according to the value of the curvilinear integrals with respect to the different ranges of values P_LINT set for the bins of the histogram.

If only the Fourier transform peak values PFFT are used to generate the classification model, then the classification table may be set from the histogram H_PFFT according to the number of occurrences of the learning data of each class CLS1, CLS2 for each bin of this histogram.

If only the values of the curvilinear integrals LINT are used to generate the classification model, then the classification table may be set from the histogram H_LINT according to the number of occurrences of the learning data of each class CLS1, CLS2 for each bin of this histogram.

To improve the performances of the classification model, the classification model may be generated by taking the Fourier transform peak values PFFT and the values of the curvilinear integrals LINT into account. In this case, the classification table may be set from the number of occurrences of the learning data of each class CLS1, CLS2 in each area ZNE of the graph GRPH having the size of each range of set values P_LINT and P_PFFT. Each area ZNE then being associated with a cell of the table of occurrences as set before.

FIG. 4 illustrates an embodiment of a computer system SYS2 configured to implement a classification method using the described classification model.

For example, the computer system SYS2 may be a microcontroller, a personal computer or a server.

The computer system SYS2 comprises a processing unit UT2 and a memory MEM2.

The computer system SYS2 includes a computer program PRG2 comprising instructions which, when the program is executed by the processing unit UT2 of the computer system SYS2, cause the latter to implement the classification method described later on. This computer program is stored in the memory MEM2.

The computer system SYS2 is configured to receive data XDAT to be classified.

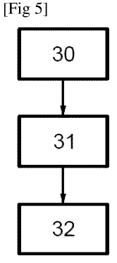

FIG. 5 illustrates an implementation of a classification method which can be executed by a computer system SYS2 as described before.

The method comprises obtaining 30 data XDAT to be classified.

Afterwards, the method comprises extracting 31 the values of the characteristics from the data XDAT to be classified. The characteristics of the data to be classified correspond to the characteristics set to establish the classification model MDL.

Afterwards, the method comprises determining 32 the class of the data to be classified XDAT using the classification model from the values of the characteristics extracted from the data to be classified XDAT.

In particular, the class of the data to be classified XDAT is determined from the classification table TAB of the classification model MDL. In particular, as indicated before, each cell of the classification table TAB is associated with one class.

The values of the characteristics extracted from the data to be classified XDAT are used to select a cell of the classification table which is associated with the ranges of the values of the characteristics that include the extracted values. This selected cell of the classification table TAB allows determining the class of the data to be classified.

In particular, the cell of the classification table TAB may be selected using the extracted values of the characteristics as well as the minimum and maximum values Minᵥₐₗ and Maxᵥₐₗ of the characteristics determined by the classification model.

In particular, the coordinates of the cell of the classification table TAB may be obtained using the following formula for each studied characteristic:

(Datᵥₐₗ−Minᵥₐₗ)/(Maxᵥₐₗ−Minᵥₐₗ/N), where Datᵥₐₗ corresponds to the value of the characteristic extracted from the data to be classified, Minᵥₐₗ corresponds to the minimum value of the characteristic determined by the classification model, Maxᵥₐₗ corresponds to the maximum vale of the characteristic determined by the classification model MDL, and N corresponds to the number of cells of the classification table associated with this characteristic (i.e. the number of ranges of values set for this characteristic).

Alternatively, if the classification model comprises all of the ranges of values set for each characteristic during generation thereof, the cell of the classification table TAB may be selected by comparing the values of the characteristics extracted at the set ranges of values.

What is claimed is:

1. A method for generating a classification model, the method comprising:
obtaining at least one group of learning data, each group of learning data being associated with an indicated class;
identifying at least one characteristic to be studied of the learning data;
extracting a value of each characteristic defined for all learning data;
identifying ranges of values for each characteristic from the extracted values;
creating a classification table having a number of dimensions corresponding to the number of studied characteristics, each dimension having a size equal to the number of ranges of values defined for the characteristic associated with this dimension, each cell of the classification table being associated with a range of values of each studied characteristic;
assigning a class to each cell of the classification table according to a number of occurrences of the learning data of each group according to their extracted value of each characteristic with respect to the ranges of values defined for each studied characteristic; and
generating the classification model comprising the classification table.

2. The method according to claim 1, wherein the classification model further includes a minimum value and a maximum value of each studied characteristic.

3. The method according to claim 1, wherein the class assigned to a cell of the classification table corresponds to the class of the group of learning data having the largest number of occurrences of learning data over the range of values of each characteristic associated with the cell of the classification table.

4. The method according to claim 1, wherein the class assigned to a cell of the classification table corresponds to the class having the highest probability compared to the classes assigned to the adjacent cells of the classification table if the number of occurrences of the learning data over the range of values of each characteristic associated with the cell is the same and non-zero for each group of learning data.

5. The method according to claim 1, wherein the class assigned to a cell of the classification table corresponds to an undetermined class or to the class having the highest probability compared to the classes assigned to the adjacent cells of the classification table if the number of occurrences of the learning data over the range of values of each characteristic associated with the cell is zero for each group of learning data.

6. The method according to claim 1, wherein the ranges of values for each characteristic are set using Sturges's rule.

7. The method according to claim 1, further comprising developing a classification computer program product comprising instructions which, when the program is executed by a computer, cause the latter to implement the generated classification model.

8. A computer system comprising:
a memory comprising a computer program, the computer program comprising instructions to:
obtain at least one group of learning data, each group of learning data being associated with an indicated class;
identify at least one characteristic to be studied of the learning data;
extract a value of each characteristic defined for all learning data;
identify ranges of values for each characteristic from the extracted values;
create a classification table having a number of dimensions corresponding to the number of studied characteristics, each dimension having a size equal to the number of ranges of values defined for the characteristic associated with this dimension, each cell of the classification table being associated with a range of values of each studied characteristic;
assign a class to each cell of the classification table according to a number of occurrences of the learning data of each group according to their extracted value of each characteristic with respect to the ranges of values defined for each studied characteristic; and
generate a classification model comprising the classification table; and
a processor configured to execute the computer program.

9. The computer system according to claim 8, wherein the classification model further includes a minimum value and a maximum value of each studied characteristic.

10. The computer system according to claim 8, wherein the class assigned to a cell of the classification table corresponds to the class of the group of learning data having the largest number of occurrences of learning data over the range of values of each characteristic associated with the cell of the classification table.

11. The computer system according to claim 8, wherein the class assigned to a cell of the classification table corresponds to the class having the highest probability compared to the classes assigned to the adjacent cells of the classification table if the number of occurrences of the learning data over the range of values of each characteristic associated with the cell is the same and non-zero for each group of learning data.

12. The computer system according to claim 8, wherein the class assigned to a cell of the classification table corresponds to an undetermined class or to the class having the highest probability compared to the classes assigned to the adjacent cells of the classification table if the number of occurrences of the learning data over the range of values of each characteristic associated with the cell is zero for each group of learning data.

13. The computer system according to claim 8, wherein the ranges of values for each characteristic are set using Sturges's rule.

14. The computer system according to claim 8, further comprising developing a classification computer program product comprising instructions which, when the program is executed by a computer, cause the latter to implement the generated classification model.

15. A classification method, the classification method comprising:
obtaining at least one group of learning data, each group of learning data being associated with an indicated class;
identifying at least one characteristic to be studied of the learning data;
extracting a value of each characteristic defined for all learning data;
identifying ranges of values for each characteristic from the extracted values;
creating a classification table having a number of dimensions corresponding to the number of studied characteristics, each dimension having a size equal to the number of ranges of values defined for the characteristic associated with this dimension, each cell of the classification table being associated with a range of values of each studied characteristic;
assigning a class to each cell of the classification table according to a number of occurrences of the learning data of each group according to their extracted value of each characteristic with respect to the ranges of values defined for each studied characteristic;
generating a classification model comprising the classification table;
obtaining data to be classified;
extracting values from the data to be classified for each characteristic defined in the classification model; and
determining the class of the data to be classified from the classification table of the classification model indicating the class assigned for the extracted values.

16. The method according to claim 15, wherein the classification model includes a minimum value and a maximum value of each studied characteristic, and wherein the class assigned for the data to be classified is found in the classification table from the values extracted from the data to be classified, the minimum and maximum values of each studied characteristic and the size of each dimension of the classification table.

17. The method according to claim 15, wherein the classification model further includes a minimum value and a maximum value of each studied characteristic.

18. The method according to claim 15, wherein the class assigned to a cell of the classification table corresponds to the class of the group of learning data having the largest number of occurrences of learning data over the range of values of each characteristic associated with the cell of the classification table.

19. The method according to claim 15, wherein the class assigned to a cell of the classification table corresponds to the class having the highest probability compared to the classes assigned to the adjacent cells of the classification table if the number of occurrences of the learning data over the range of values of each characteristic associated with the cell is the same and non-zero for each group of learning data.

20. The method according to claim 15, wherein the class assigned to a cell of the classification table corresponds to an undetermined class or to the class having the highest probability compared to the classes assigned to the adjacent cells of the classification table if the number of occurrences of the learning data over the range of values of each characteristic associated with the cell is zero for each group of learning data.
